(19) United States
(12) Patent Application Publication
(10) Pub. No.: US 2017/0077590 A1
(43) Pub. Date: Mar. 16, 2017

(54) SIMPLIFIED ELECTRONIC MODULE FOR A SMARTCARD WITH A DUAL COMMUNICATION INTERFACE

(71) Applicant: SMART PACKAGING SOLUTIONS, Rousset (FR)

(72) Inventors: Bernard CALVAS, Rousset (FR); Didier LIVRATI, Rousset (FR)

(73) Assignee: SMART PACKAGING SOLUTIONS, Rousset (FR)

(21) Appl. No.: 15/123,375

(22) PCT Filed: Mar. 3, 2015
(86) PCT No.: PCT/FR2015/000046

§ 371 Date: Sep. 2, 2016

(30) Foreign Application Priority Data
Mar. 3, 2014 (FR) 1400545

(51) Int. Cl. H01Q 1/22; G06K 19/077

(52) U.S. Cl. CPC H01Q 1/2283; G06K 19/07769; G06K 19/07722; G06K 19/07735; H01Q 1/2291

(57) ABSTRACT

An electronic module for a smartcard has a dual, contact and contactless, communication interface. The module includes an electrically insulating substrate on which are produced electrical contact pads enabling operation via contact with corresponding contacts of a smartcard reader, and contact pads for connection to corresponding pads of an antenna located on the body of the smartcard and enabling a contactless operation with a remote smartcard reader. The substrate is coated with a single electrically conductive layer, especially one made of metal, located on the lower face of the electronic module, and the upper face of the electronic module, which face is intended to be flush with the external face of the smartcard, is produced by said electrically insulating substrate, the latter being provided with windows leaving exposed all or some of said electrical contact pads.

The invention relates to an electronic module for a chip card with a dual, contact and contactless, communication interface, and a chip card integrating such a module.

### PRIOR ART

Chip cards with mixed, contact and contactless, operation already exist in the prior art. Most have a microelectronic module equipped with contacts, said module having a radiofrequency communication interface connected to the terminals of an antenna which is itself produced either in the body of the card, or on the electronic module itself.

Thus, most cards with a dual communication interface in accordance with the prior art are composed of:
an electronic module comprising a microelectronic chip, a contact connection terminal block intended to be placed in contact with the corresponding terminals of a contact chip card reader, and two electrical contacts located on the back face of the electronic module and allowing the connection to be made to the antenna of the card body;
a card made of a plastic material in ISO 7816-1 format, comprising an antenna, in particular in the format referred to as the ID1 format;
an electrically conductive material allowing the connection to be made between the electronic module and the antenna.

In order to overcome certain manufacturing problems, it was conceived, in another known type of dual-operation chip card, to integrate the antenna directly on the microelectronic module, and subsequently to simply transfer the module into a chip card body, which is easy to achieve at low cost and with high reliability using most conventional chip implanting machines used in the manufacture of contact chip cards.

However, a residual problem appeared, even in the most advanced modules known in the prior art, in that the electrical contacts of the terminal block are located on one face of the substrate, and the turns of the antenna are located on the opposite face of the substrate, thereby making it necessary to produce metallic vias between the two faces of the substrate in order to connect the terminals of the chip to the electrical contacts of the terminal block of the module, and to the terminals of the antenna that are located on the opposite face.

These vias also allow an electrical connection bridge, or “strap”, to be produced, composed of two vias connected to one another by an electrical connection that spans the turns of the antenna and connects the outermost antenna connection pad, or distal pad, to a proximal connection pad of the antenna, which pad is located in proximity to the terminal of the contactless communication interface of the chip. This arrangement makes it possible, on the one hand, to connect the bonding wires to the chip in a standard manner in terms of loop height and wire length and, on the other hand, to provide a peripheral bonding area on the module that is sufficient for the subsequent transfer thereof to the card body.

However, this structure using vias also poses a series of problems in the production of the electronic module.

Specifically, using a substrate containing vias makes the structure expensive, as in order to produce the vias it is first necessary to make holes through the substrate, then to clean up the holes and activate the sidewalls thereof with carbon or palladium so as to make them conductive in order to allow the metalization thereof in a subsequent step, then to provide the via with a metalized finish and thus electrically connect the two faces of the substrate.

It is known that the metalization of the vias will cause an increase in the thickness of copper possibly reaching 20 microns on each side of the substrate, which is often critical for thin products such as chip card modules.

Furthermore, the steps of manufacturing vias introduce additional quality control steps and decreases in overall manufacturing yield, thereby increasing unit cost with respect to a product without vias.

Additionally, the metal on the edge of the vias or bonding holes poses another problem, as there is a risk of an electrical short circuit between the wiring connected through a hole to an ISO contact and the metal on the edge of the hole, which is electrically connected to the antenna. An ISO contact may then be inadvertently connected to the antenna. This fault becomes all the more likely as the length of the bonding wires between the chip and ISO contacts increases, in particular when they are more than 2 mm in length, and all the more severe as it is not necessarily detected in the tests carried out by the manufacturer of the electronic module, while the performance of the card in the field in contactless mode is greatly reduced.

An electronic module for a chip card is also known from document DE 196 32 115 C1, in this instance endowed with a substrate comprising a single metalized face, and in which the antenna is located on the module itself. The antenna is then produced via fine turns etched into the top face of the module, which also comprises the ISO contacts of the module that can be accessed by a contact chip card reader. The etched fine turns are exposed to contact with fingers, or more generally to the environment in which the chip card is used, thereby tending to rapidly damage the turns and to make operation of the chip card in contactless mode impossible. Furthermore, as the antenna is entirely located on the electronic module, its surface area is low, thereby limiting performance and the communication range of the chip card in contactless mode. Moreover, the terminals of the antenna are located in the encapsulation area, thereby making the electronic module described in this document incompatible with the use of an antenna in ID1 format located on the periphery of the chip card body, which antenna has a longer communication range. Lastly, in the electronic module according to this document, the ISO contacts and the turns of the antenna of the module are located on the top, visible face of the module, and the area thus occupied is such that this module cannot be subject to a graphical personalization on its visible top face.

### AIMS OF THE INVENTION

A general aim of the invention is consequently to propose an electronic module for a chip card with a dual, contact and contactless, communication interface, which is free of the aforementioned drawbacks.

Another aim of the invention is to propose an electronic module for a chip card with a dual, contact and contactless, communication interface, which may be manufactured more simply and be less expensive than the known modules, without affecting the high level of reliability.

A particular aim of the invention is to propose an electronic module for a chip card with a dual, contact and contactless, communication interface, requiring no interconnections or vias between the faces of the substrate, and capable of solving the problems of a risk of short circuit between the ISO contacts of the chip card and its antenna.

### SUMMARY OF THE INVENTION

To this end, the principle of the invention is that the antenna connection pads of the chip card, and the ISO contacts of the module according to ISO standard 7816-2, are located on one and the same single face of the module, namely the back or bottom face of the substrate of the module, the front face that is visible after the module has been implanted into a chip card body being composed of an essentially electrically insulating face and being able to receive any type of informative marking or graphical personalization.

One subject of the invention is consequently an electronic module for a chip card with a dual, contact and contactless, communication interface, said module comprising an electrically insulating substrate on which, on the one hand, electrical contact pads, allowing an operation by contact with the corresponding contacts of a chip card reader, and, on the other hand, contact pads for making the connection to corresponding pads of an antenna located on the body of the chip card and allowing the contactless operation thereof with a remote chip card reader, are produced, characterized in that said substrate is coated with a single electrically conductive, in particular metallic, layer located on the bottom face of the electronic module, and in that the top face of the electronic module, which face is intended to be flush with an outer face of the chip card, is produced by said electrically insulating substrate, the latter being provided with windows allowing all or part of said electrical contact pads to be visible.

Preferably, the electrically insulating layer is chosen so as to easily allow a graphical personalization to be produced, via printing or equivalent.

This advantageous embodiment allows, in particular, the low cost of use of a substrate having a single metalized or conductive face to be combined with the possibility to graphically personalize, print or mark the surface of the module located between the apertures or windows corresponding to the ISO contact terminals.

Preferably, as it is an electronic module for a chip card with dual, contact and contactless, operation, the electronic chip of the module is located in an encapsulation area protecting the chip, and the contact pads for making the connection to an antenna are located outside said encapsulation area. In this way, the insertion of the module according to the invention into the cavity of a chip card body additionally makes it possible to obtain a chip card that provides high-performance operation in contactless mode, due to the presence of a large antenna whose size is greater than the size of the electronic module, and in particular in ID1 format.

Another subject of the invention is a chip card with a dual, contact and contactless, communication interface, comprising an electronic module such as described above.

Other features and advantages of the invention will become apparent upon reading the detailed description and the appended drawings in which:

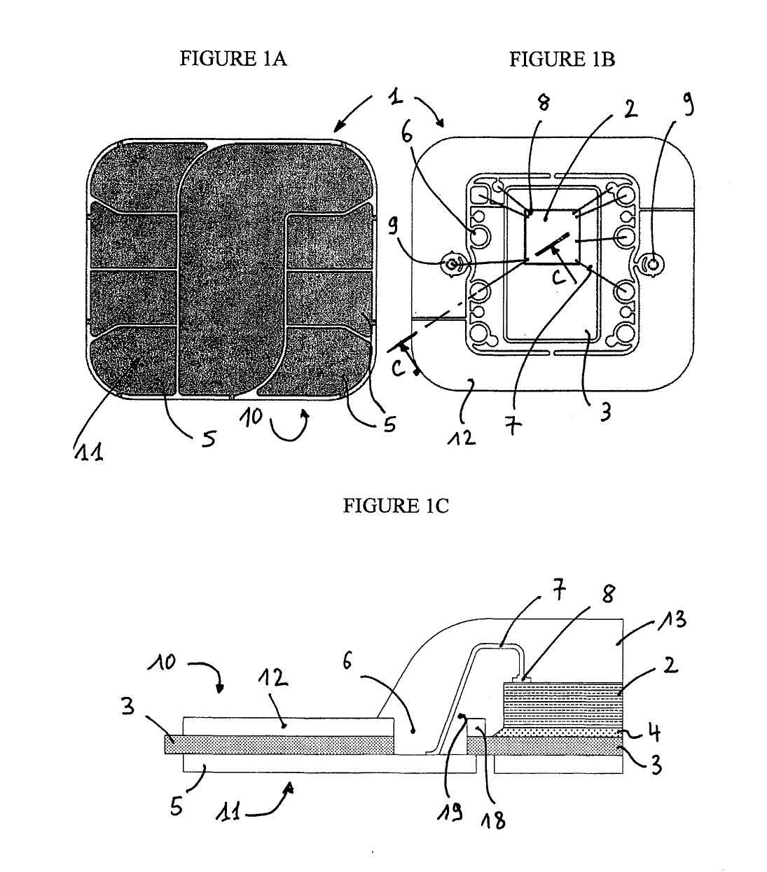

FIGS. 1A and 1B illustrate, respectively, a plan view from above and from below of an electronic module for a chip card, conforming to the prior art;

FIG. 1C illustrates a cross-sectional view of the electronic module of FIG. 1B along a sectional plane CC;

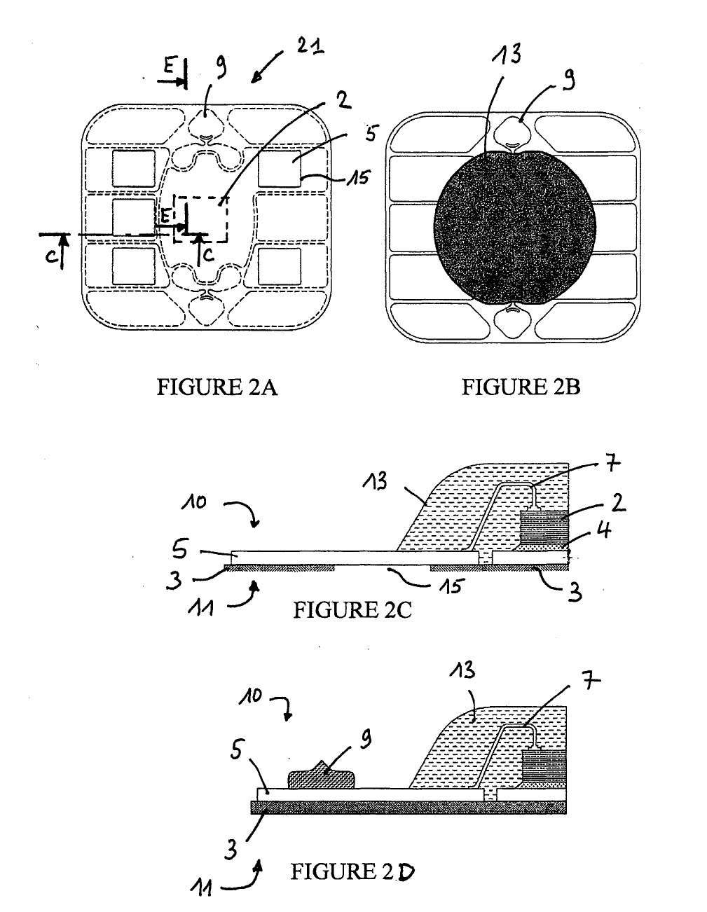

FIGS. 2A and 2B illustrate, respectively, a plan view from above and from below of an electronic module according to the invention;

FIGS. 2C and 2D illustrate cross-sectional views of the module of FIGS. 2A, 2B along multiple sectional planes.

### DETAILED DESCRIPTION

As indicated above, FIGS. 1A and 1B illustrate a known electronic module 1, including a chip 2 bonded, using a layer of adhesive 4 (FIG. 1C), to an electrically insulating substrate 3. The chip 2 is connected, on the one hand, to a terminal block with electrical contacts (5) located on the top face 11 of the module, which is opposite the bottom face 10 bearing the chip, these contacts 5 being intended to provide for operation in contact mode with a contact reader (not shown). The electrical connections between the ISO contacts 5 and the corresponding output pads of the chip 2 are made through commonly known vias 6, also called bonding holes, which allow the output pads 8 of the chip to be electrically connected, using bonding wires 7, to the ISO contacts 5 located on the opposite face of the module.

The chip 2 is connected, on the other hand, to an antenna located in a card body or directly on the module 1, via metallic pads 9 located on the bottom face 10 of the module, the connection to the antenna allowing radiofrequency communication with a contactless chip card reader (not shown).

The module 1 comprises, on its bottom face 10, a peripheral surface 12 intended for the bonding of the module in the cavity of the chip card body provided for this purpose, and the antenna pads 9 are typically located on this peripheral surface 12, outside an encapsulation area 13 formed by a resin that protects the chip and its connections 7 to the ISO contacts 5.

The electrical contacts 5 of the terminal block are located on a face of the substrate of the module, corresponding to the top face 11 of the module, and the chip is located on the opposite face of the substrate, corresponding to the bottom face 10 of the module.

It will therefore be seen that in this known structure of a module for a chip card, the substrate 3 of the module is of the type referred to as “double-sided”, i.e. it comprises two metalized faces, namely a first metalized face (the top face 11 in the example shown) that bears the metallic ISO contacts 5, and a second face that is partially metalized (the bottom face 10 in the example shown) which bears the metallic solder pads 9 for making the connection to the antenna, and vias 6 for making the connections between the chip and the ISO contacts. The vias 6 for making connections to the contacts 5 are located inside the encapsulation area delimited by the resin 13 protecting the chip. It is typically a blob of polymerizable resin, while the pads 9 for making connection to the antenna are located inside or outside the encapsulation area, depending on whether the antenna is produced directly on the electronic module or on the body of the chip card.

In any case, the embodiment shown that corresponds to the prior art requires the substrate of the module to be metalized (i.e. at least partially coated with a layer of metal) on both of its faces.

The face referred to as the upper face of the module is defined as that which remains visible when the module is implanted into a chip card body. Consequently, in the example shown that corresponds to the prior art, the ISO contacts 5 are on the top face 11 of the module, and the chip 2 is bonded to the bottom face 10 of the module.

This double metalization is problematic in certain cases of use, as it effectively doubles the unit cost of an electronic module for a chip card with respect to a module having only one metalized substrate face. In particular, as seen in FIG. 1C, the area 18 that surrounds the via 6 is metallic and leaves only a small space 19 with respect to the bonding wire 7 which is also metallic, thereby running the risk of a short circuit as mentioned above.

The present invention has therefore sought to design an electronic module referred to as a single-sided electronic module, having a single, preferably metalized, conductive face, in order to reduce the procurement costs of the substrate of the module, while avoiding the problems of low communication performance and low resistance to wear mentioned in relation to the module described in the aforementioned document DE 196 32 115 C1.

The solution obtained is that shown schematically in FIG. 2. One and the same functional element is denoted by the same numerical reference in each of FIGS. 1 and 2. The thickness of the module in cross-sectional view is exaggerated for the sake of clarity.

In the electronic module 21 according to the invention, the substrate 3 is indeed coated with a single metalized layer. However, in contrast to the aforementioned document, it is located on the bottom face 10 side of the module, the top face 11 of the module being composed of an electrically insulating layer (the substrate 3) made of a plastic material or of a dielectric material. This electrically insulating layer is provided with a series of apertures 15, also referred to as “windows”, which allow the ISO contacts 5 produced on the bottom face of the module to be at least partially visible. In this way, the ISO contacts 5 remain accessible to the corresponding contacts of a contact chip card reader.

Thus, as the top face 11 of the electronic module is essentially (i.e. apart from the area of the windows 15) composed of a plastic material, it is easily graphically personalized, by printing information or logos relating to the application of the chip card, or to its issuer (bank, etc.).

In order to allow the chip card to communicate via radiofrequency, an antenna is required. However, according to the invention, this antenna is not produced on the module itself as taught in document DE 196 32 115 C1. An antenna of larger size, typically in ID1 format, is used. In order to be able to connect it to the electronic module 21, the latter comprises, on its single metalized side 10, two antenna pads 9 produced outside the encapsulation area of the chip. Homologous pads (not shown) are then produced in a known manner in the cavity of the card body that is able to receive the electronic module, and the insertion of the module into the card body makes the electrical connection between the antenna pads of the card body and the antenna pads of the module.

### Advantages of the Invention

Specifically, the invention proposes a design of electronic module, in particular for chip card with dual-mode, contact and contactless, communication chip, having a particularly innovative but simple design, employing a substrate which is very economical since it is provided with a single metallized conducting side, while maximizing radiofrequency communication performance by using an antenna of large format (ID1 format), and while leaving a plastic area of relatively large size, which lends itself readily to graphical personalization, free on the top face of the module. In this sense, the invention makes it possible to meet several constraints which go beyond those typically imposed on a chip card module.

The invention therefore allows the manufacture of an electronic module capable of optimizing the best compromise between cost and simplicity of manufacture, operational performance in radiofrequency mode, and the use of the visible surface of the module as communication support.

Moreover, the design of an electronic module having a single conducting face makes it possible to solve the problems of short-circuiting between antenna and ISO contacts, which exist for certain modules according to the prior art.

Furthermore, all the combinations of assembly which are known in the prior art (“flipchip”, “wire deposition”, transfer molding, etc.) remain possible with this design of module.

1. An electronic module for a chip card with a dual, contact and contactless, communication interface, said module comprising:
an electrically insulating substrate on which are disposed a first set of electrical contact pads, allowing an operation by contact with corresponding contacts of a chip card reader, and a second set of contact pads for connection to corresponding pads of an antenna located on a body of the chip card and allowing the contactless operation thereof with a remote chip card reader,
wherein said substrate is coated with a single electrically conductive layer located on a bottom face of the electronic module, and wherein a top face of the electronic module, which face is intended to be flush with an outer face of the chip card, is produced by said electrically insulating substrate, the substrate being provided with windows allowing all or part of said electrical contact pads to be visible.

2. The electronic module as claimed in claim 1, wherein said electrically insulating substrate is capable of receiving a graphical personalization, via printing or equivalent.

3. The electronic module as claimed in claim 1, wherein an electronic chip of the module is located in an encapsulation area protecting the chip, and wherein said contact pads for making the connection to an antenna are located outside said encapsulation area.

4. A chip card with a dual, contact and contactless, communication interface, comprising an electronic module as claimed in claim 1.
